(19) United States
(12) Patent Application Publication
(10) Pub. No.: US 2016/0089846 A1
(43) Pub. Date: Mar. 31, 2016

(54) EXTRUDED HEAT SHRINK PROTECTIVE SEAMLESS PVC PILING SLEEVE AND METHOD

(71) Applicant: Shoreline Planstics, LLC, Jacksonville, FL (US)

(72) Inventors: Stafford McCartney, Jacksonville, FL (US); Mark Porter, Jacksonville, FL (US)

(73) Assignee: Shoreline Plastic, LLC, Jacksonville, FL (US)

(21) Appl. No.: 14/312,663

(22) Filed: Jun. 23, 2014

(51) Int. Cl. B32B 1/08; B29C 65/56; B32B 27/30; B29C 47/00

(52) U.S. Cl. CPC B32B 1/08; B29C 47/0054; B29C 47/0066; B29C 65/565; B32B 27/304

(57) ABSTRACT

A continuously extruded seamless PVC pipe shrinks to about 50% of its extruded size when reheated to a specific temperature. Prior to shrinking, the extruded pipe is slid over a wooden piling, dimensional lumber, railroad tie or other metal or wood substrate. Upon application of heat, the pipe will shrink to encapsulate the substrate in a hermetically sealed, durable membrane. This impervious membrane will prevent any attack on the substrate by boring and surface destroying organisms and substances.

### FIELD OF THE INVENTION

This invention relates generally to methods and devices for protecting elongated substrates, such as wood pilings, utility poles, railroad ties and steel beams and columns, and, more particularly, to a seamless heat shrinkable protective polyvinyl chloride sleeve.

### BACKGROUND

Marine growth and wood boring infestation on wood pilings and timbers used in marine applications have been an extremely costly problem for centuries. Similar problems plague terrestrial structures. Many attempts have been made to protect such structures from the ravishes of harmful organisms, from surface treatments or impregnating the wood with chemical solutions to inhibit the attachment of the various infestations.

Some prior attempts entail wrapping a wood piling in a flexible heat shrinkable plastic sheet. A seam formed by overlapping edges is bonded closed, and the wrap is heated to shrink to a snug fit. The overlapping edges that form the seam comprise double the width of the material of the sheet. Consequently, the heat that is sufficient to shrink the wrap away from the seam is insufficient to shrink the double width seam. Thus, a gap may be formed at the seam that allows intrusion by water and marine organisms. Furthermore, shrinkage of the wrap exerts tensile and shear stresses at the seam. These stresses may compromise the integrity of the seam, causing further intrusion. Thus, a seamless shrink wrap sleeve is needed.

Another problem with prior art wraps is failure to bond sufficiently to the substrate, particularly wood piling its inherent surface irregularities. High viscosity of hot melt adhesive disposed between the wrap and piling requires considerable pressure to bond with the wood piling. Various techniques and devices for applying pressure while heating have been devised. However, these devices are costly and cumbersome and time consuming to use. Additionally, these devices are prone to applying pressure over targeted areas, with considerable pressure gradients between targeted areas and other areas. This can result in uneven and weak bonding, which increases risk of de-bonding (i.e., delamination) and formation of gaps that are vulnerable to intrusion. Thus, an improved bonding mechanism is needed.

Yet another problem with prior art is that the protective wrap may be limited to use with certain materials and shapes. A protective cover suitable for use with a variety of substrates and shapes, whether or not used in marine applications, is needed.

The invention is directed to overcoming one or more of the problems and solving one or more of the needs as set forth above.

### SUMMARY OF THE INVENTION

To solve one or more of the problems set forth above, in an exemplary implementation of the invention, a continuously extruded seamless PVC pipe manufactured from a combination of a unique PVC compound and a specialized extrusion process that enables the pipe to shrink to about 50% of its extruded size when reheated to a specific temperature is provided.

The extruded pipe can be slid over substrates, such as pilings, beams, ties, columns and dimensional lumber. Upon application of heat, the pipe will shrink to encapsulate substrates into a hermetically sealed, robust membrane. This seamless impervious membrane will prevent any attack on the wooden substrate by internal wood boring or surface destroying organisms.

In one embodiment, the shrink pipe has a continuous or intermittent coating of a heat sensitive adhesive applied to its inner wall after extrusion and expansion, so that when the pipe is heat shrunk to take the shape of the substrate the adhesive creates a bond between the substrate and the PVC pipe. The substrate being encapsulated can be of any length, tapering or parallel, treated or untreated with a diameter up to 24 inches, or larger depending upon the dimension of the extrusion die and expansion mandrel.

A method of protecting a structure (e.g., a wood piling, railroad tie, dimensional lumber or other wood or metal structure) according to principles of the invention entails encasing at least a portion of the structure in a heat shrunk seamless PVC pipe. The pipe is produced by heating a PVC dry blend until a melt is formed. The blend may include a fungicide. The melt is extruded through a die to form a seamless PVC pipe having an outer surface, an inner surface and an unexpanded inner diameter greater than two inches. The extruded PVC pipe is cooled to a first temperature below a glass transition temperature for the PVC pipe. After cooling, the extruded PVC pipe is heated to a second temperature at least about the glass transition temperature for the PVC pipe. After heating the extruded PVC pipe to the second temperature, the PVC pipe is expanded from the unexpanded inner diameter to an expanded inner diameter. The unexpanded inner diameter is about one half (e.g., ¼ to ¾) of the expanded inner diameter. The maximum width (e.g., diameter) of the structure is between the unexpanded inner diameter and expanded inner diameter. Optionally, after expansion, a hot melt adhesive, which has a low viscosity when melted (e.g., less than 15,000 centipoise) and may contain a fungicide, is applied onto at least a portion of the inner surface of the PVC pipe. After expanding, the PVC pipe is cooled to a second temperature below the glass transition temperature for the PVC pipe. Then the PVC pipe may be cut to a determined size.

The step of expanding the PVC pipe entails passing the PVC pipe over a mandrel having a first cylindrical section with a first mandrel diameter about equal to the unexpanded inner diameter, and a second cylindrical section with a second mandrel diameter about equal to the expanded inner diameter, and a conical frustum disposed between and coupling the first cylindrical section to the second cylindrical section. The conical frustum, first cylindrical section and second cylindrical section are concentric. The mandrel may also include several sizing discs, each having a disc diameter about equal to the expanded inner diameter. Each of the sizing discs is concentric with the second cylindrical section and spaced apart from each other and the second cylindrical section. A negative pressure may be maintained at the mandrel as the PVC pipe passes over it during expansion.

A cut segment of pipe is slid over at least a portion of the structure (e.g., piling or tie). The structure may be lifted with a forklift, such as a forklift equipped with a cylindrical sleeve for holding the structure in a cantilever manner on the forks. A heat source heats the PVC pipe on the structure until the temperature of the PVC pipe reaches the glass transition temperature for the PVC pipe, whereupon the heated PVC pipe shrinks from the expanded inner diameter towards the unexpanded inner diameter. For an embodiment with hot melt adhesive, heating melts the adhesive and the shrinking action compresses the adhesive into the structure, thereby forming an intimate bond. Afterwards, the pipe is allowed to cool. After cooling, the encased structure may be utilized.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level schematic of an exemplary system for extruding seamless heat shrinkable pipe according to principles of the invention; and

FIG. 2 is a perspective view of an exemplary expander for a system according to principles of the invention; and

FIG. 3 is a plan view of an exemplary expander for a system according to principles of the invention; and

FIG. 4 is a section view of an exemplary hot melt adhesive applicator for a system according to principles of the invention; and

FIG. 5 is a flowchart for an exemplary method of producing a seamless heat shrinkable sleeve according to principles of the invention; and

FIG. 6 is a side view of an exemplary piling holder for a forklift according to principles of the invention; and

FIG. 7 is a perspective view of an exemplary piling holder for a forklift according to principles of the invention; and

FIG. 8 is a side view of an exemplary forklift with a piling holder in a lowered position according to principles of the invention; and

FIG. 9 is a side view of an exemplary forklift with a piling holder in a raised position according to principles of the invention; and

FIG. 10 is a flowchart for an exemplary method of applying a seamless heat shrinkable sleeve to a piling according to principles of the invention; and

FIG. 11 is a perspective view of an exemplary extruded heat shrink protective seamless piling sleeve according to principles of the invention; and

FIG. 12 is a section view of an exemplary extruded heat shrink protective seamless piling sleeve according to principles of the invention; and

FIG. 13 is a profile view of an exemplary extruded heat shrink protective seamless piling sleeve with a surrounded piling and a gap between the piling and sleeve according to principles of the invention; and

FIG. 14 is a perspective view of an exemplary extruded heat shrink protective seamless piling sleeve with a surrounded piling and a gap between the piling and sleeve according to principles of the invention; and

FIG. 15 is a profile view of an exemplary extruded protective seamless piling sleeve with a surrounded piling and no gap between the piling and sleeve because the sleeve had been shrunk by applying heat according to principles of the invention; and

FIG. 16 is a perspective view of a heat shrink rectangular end cap for use with an exemplary extruded protective seamless piling sleeve with a surrounded piling according to principles of the invention; and

FIG. 17 is a perspective view of a heat shrink circular end cap for use with an exemplary extruded protective seamless piling sleeve with a surrounded piling according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

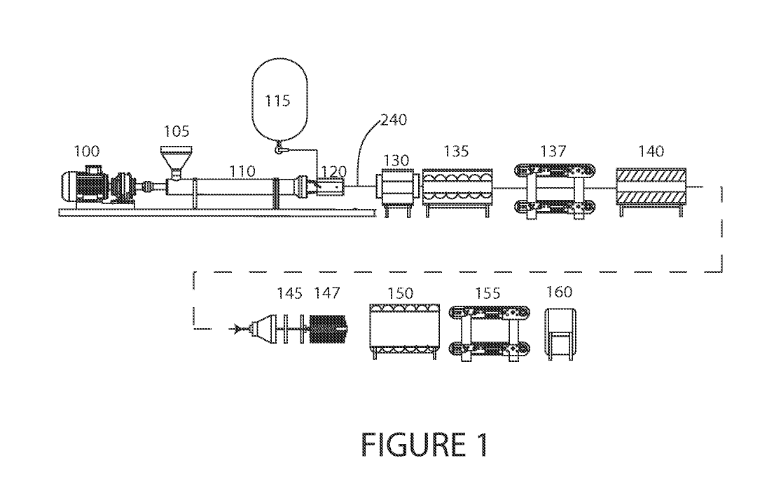

FIG. 1 is a high level schematic of an exemplary system for extruding seamless heat shrinkable pipe according to principles of the invention. The dashed line illustrates an exemplary linear aligned progression of steps. Raw material comprising a dry blend of polyvinyl chloride powder or pellets and other ingredients that are stabilized for both heat and UV protection are introduced through a hopper 105. The dry blend PVC compound to be extruded into heat shrinkable pipe includes ingredients to both reflect and absorb ultra-violet rays, coloring pigments, process stabilizers, flexibility enhancers, surface migrating ablative fungicides/biocides and algaecides. A non-limiting example of an exemplary blend is provided below in Table 1.

TABLE 1

| Parts* | Wt % | Material | Lbs |
|---|---|---|---|
| 100 | 78.25% | PVC Resin | 460.00 |
| 4 | 3.13% | Ultra-Violet Inhibitor | 18.40 |
| 5 | 3.91% | UFT Calcium Carbonate | 23.00 |
| 0.8 | 0.63% | Calcium Stearate | 3.68 |
| 1.2 | 0.94% | Paraffin Wax | 5.52 |
| 0.2 | 0.16% | Oxidized Polyethylene | 0.92 |
| 7 | 5.48% | Plasticizer | 32.20 |
| 0.02 | 0.02% | Marine Growth Inhibitor | 0.09 |
| 1.2 | 0.94% | Heat Stabilizer | 5.52 |
| 4 | 3.13% | Process Aid | 18.40 |
| 0.38 | 0.30% | Grey Color | 1.75 |
| 3 | 2.35% | Epoxidized Soy Bean Oil | 13.80 |
| 1 | 0.78% | Ultra-Violet Absorbative | 4.60 |
| 127.8 | 100.0% | TOTALS | 587.88 |

*Parts by weight per 100 parts of PVC resin

A motor 100 powers one or more screws of an extruder 110. The extruder heats the raw material supplied through a hopper 105, and forces the resulting melted polymer through an extrusion die 120. The molten polymer leaves the extruder barrel in the form of one or more ribbons or molten streams.

Optionally, a heated receptacle 115 and gear pump supplies hot melt adhesive through a heat resistant (e.g., nylon) tube that passes through the die spider located in the mid region of the die 120 and continues to connect through the sizing mandrel 145 and subsequently to the hot melt adhesive applicator 147 where the hot melt is evenly sprayed on the interior wall of the blown (i.e., expanded) pipe.

The extrusion die 120 supports and distributes the homogeneous polymer melt around a solid mandrel, which forms the melt into an annular shape for a solid wall pipe. The formed solid wall pipe is also referred to herein as a “sleeve.” The formed pipe is seamless, though it may exhibit artifacts from the extrusion process.

The invention is not limited to pipes with an adhesive applied to the inner surface. In embodiments having the adhesive, the invention is not limited to the applicator 125 described above. The adhesive may be co-extruded or applied in any other manner suitable for a continuous extrusion process.

Nonlimiting examples of hot melt adhesives include ethylene-vinyl acetate copolymers; ethylene-acrylate copolymers, such as ethylene-vinylacetate-maleic anhydride and ethylene-acrylate-maleic anhydride terpolymers, ethylene n-butyl acrylate, ethylene-acrylic acid and ethylene-ethyl acetate; polyolefins, such as amorphous polyolefin polymers; polybutene-1 and its copolymers; polyamides; thermosetting polyurethanes; styrene copolymer adhesives and rubber-based adhesives, such as styrene-butadiene-styrene, styrene-isoprene-styrene, styrene-ethylene/butylene-styrene, and styrene-ethylene/propylene. To reduce viscosity of the melt, tackifying resins and waxes may be added to the adhesive. Tackifying resins may include rosins and their derivates, terpenes and modified terpenes, aliphatic, cycloaliphatic and aromatic resins, hydrogenated hydrocarbon resins, and terpene-phenol resins. Waxes may include microcrystalline waxes, fatty amide waxes or oxidized Fischer-Tropsch waxes, which lower the melt viscosity and can improve bond strength and temperature resistance. A hot melt adhesive with a softening point of less than 250° F. and a viscosity at 350° F. of 15,000 centipoise or less is preferred. Such an adhesive melts during heat shrinking and flows freely into and bonds well with the substrate, without requiring pressure beyond the pressure exerted by the seamless shrinking pipe.

In a particular embodiment the adhesive is comprised of ethylene vinyl acetate (EVA) with a viscosity of about 10,500 centipoise at 350° F. The heat application used to shrink the pipe reactivates the EVA and provides a strong but flexible bond between the substrate and the PVC pipe.

The dimensions and heat shrink properties of the pipe are determined and set during sizing, reheating and cooling operations. A sizing operation holds the pipe in its proper dimensions during cooling of the material. The process is accomplished by drawing the hot material from the die 120 through a sizing sleeve 130 upstream of a cooling tank 135. Sizing may be accomplished by using either vacuum or pressure. By way of example, in a vacuum sizing system, hot extrudate is drawn through a sizing tube 130 or rings while its surface is cooled enough to maintain proper dimensions and a circular form. The outside surface of the pipe may held against the sizing sleeve by vacuum or negative pressure.

After the pipe exits the vacuum sizing tank 130, it is moved through one or more spray or immersion cooling tanks 135. Various methods of cooling may be utilized to remove residual heat from the pipe. The system may use either total immersion or spray cooling, though spray cooling is usually applied to large diameter pipe where total immersion would be inconvenient. Cooling water temperatures may be in the range of 40° to 55° F. The cooling tank 135 may contain annealing zones to minimize residual stresses by allowing heat contained within the inner pipe wall to radiate outward and anneal the entire pipe wall. The total length of the cooling bath must be adequate to cool the pipe below its glass transition temperature (t_{g}), e.g., below about 175° F. or whatever the t_{g} is for the particular pipe, in order to set an initial unexpanded diameter. In an exemplary implementation, the pipe is cooled to about 150° F. to 120° F.

As drawn through the cooling tank 135, the pipe solidifies from the outside of the wall to the inside of the wall. To cool completely, all the heat energy stored within the wall of the product must be transferred to the water of the cooling tank on the outside of the product. The thinner the wall of the final product, the faster it will cool to the desired temperature. The heavier the wall of the product, the slower it will transfer heat and cool to a uniform solid state. As a poor thermal conductor, the plastic absorbs and relinquishes heat fairly slowly. After spending quite a bit of time being heated in the resin hopper, then heated and sheared in the extruder, and then formed into shape in the heated extrusion die, the product will take some time to give up that stored heat. The thermal conductivity of the resin is a fixed value, heat will only be transferred so fast, no matter how cold the water in the quench tank may be.

After emerging from the cooling tank 135, the pipe is reheated in heater 140. The heater 140 contains one or more heating elements configured to raise the temperature of the pipe to its glass transition temperature or slightly above the glass transition temperature. By way of example and not limitation, the temperature of the pipe may be increased to about 160° F. to 190° F. in the reheater 140.

PVC resin melts when its temperature becomes higher than its melting point and becomes softened and amorphous, but as it is gradually cooled from the softened and amorphous state its viscosity gradually increases, and it goes into a rubbery state and it finally solidifies. The rubbery state lends softness and flexibility to the polymer. The temperature at the border from the rubbery state to the solid state (called the glass state) is called its “glass transition temperature.” The glass transition temperature is generally indicated as T_{g}. The glass transition temperature for PVC depends upon the cooling rate and molecular weight distribution and may be influenced by additives. Without plasticizer, the T_{g} for PVC is about 158° F. to 90° C. 194° F. For a plasticized PVC, the T_{g} may be about 125° F. to 60° C. 150° F. As a rule of thumb, most polymers will have a ratio of T_{g}/Tₘ of between 0.50 and 0.75, where Tₘ is the polymer's melting point (° K). A precise glass transition temperature may be determined for a particular PVC dry blend by differential scanning calorimetry.

Differential scanning calorimetry or DSC is a thermoanalytical technique in which the difference in the amount of heat required to increase the temperature of a sample and a reference is measured as a function of temperature. The reference has a well-defined heat capacity over the range of temperatures to be scanned. Both the sample and a reference are maintained at nearly the same temperature throughout a test. When the sample undergoes a physical transformation such as a phase transition, more or less heat will need to flow to it than the reference to maintain both at the same temperature. For example, as a PVC sample melts to a softened and amorphous it will require more heat flowing to the sample to increase its temperature at the same rate as the reference. This is due to the absorption of heat by the sample as it undergoes the endothermic phase transition from solid to softened and amorphous. By observing the difference in heat flow between the sample and reference, differential scanning calorimeters are able to measure the amount of heat absorbed or released during such transitions as well as during more subtle physical changes, such as glass transitions.

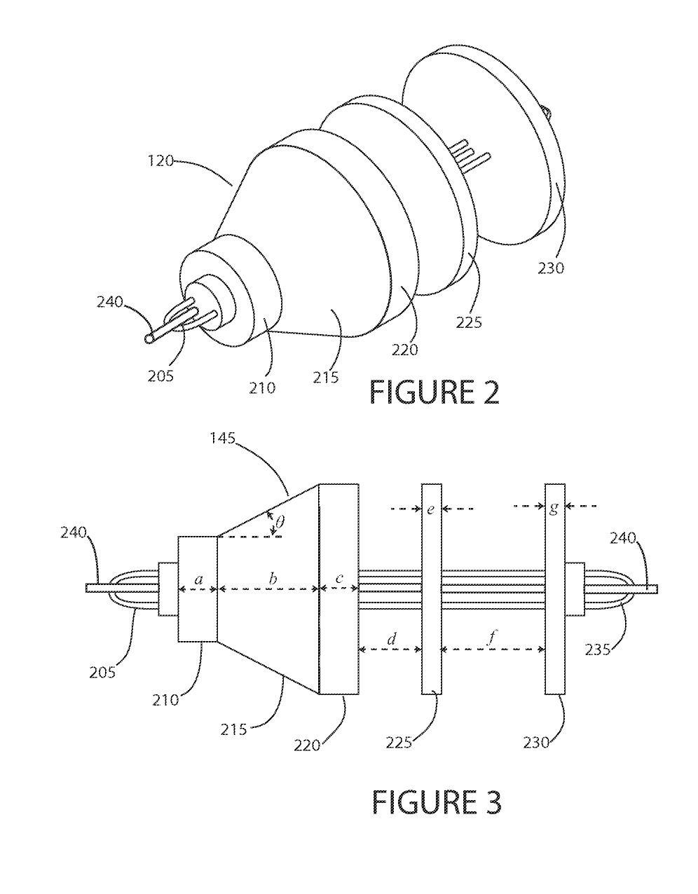

After emerging from the reheater 140, the pipe passes over an expander 145 (aka sizing mandrel) where its diameter is increased, e.g., doubled. With reference to FIGS. 2 and 3, the expander 145 includes a first mandrel 210 having a diameter about equal to the inner diameter of the unexpanded pipe. The expander includes a second mandrel 220 having a diameter about equal to the inner diameter of the expanded pipe. The expanded diameter is about double the unexpanded diameter. A frustum 215 provides a transition between the first and second mandrel 210, 220. A plurality of (e.g., 2) discs 225, 230 are provided downstream of the second mandrel 220. A pair of couplings 205, 235 allow connection of the expander between the die 120 and downstream components (i.e., cooling station 150). The couplings 205, 235 may be connected to upstream and downstream components by chains. Each disc 225, 230, has a diameter that is about the same as the diameter of the second mandrel 220. Pressure or a vacuum may hold the inner side of the pipe against the mandrels 210, 220 and discs 225, 230 for sizing. Exemplary, nonlimiting, dimensions for the measurements illustrated in FIG. 3 are a=1.5 in., b=4.5 in., c=1.5 in., d=1.5 in., e=0.75 in., f=3.0 in., g=0.75 in., with θ=28.8° and the diameter of the first mandrel being 4 in. and the diameter of the second mandrel 220 and each disc 225, 230 being 8 in. Having an angle θ of 30° or less, the frustum 120 provides a gradual transition from the unexpanded to the expanded diameters.

The expanded diameter may be double the unexpanded diameter. The piling diameter will be between the expanded diameter and the unexpanded diameter. In a preferred implementation, the piling diameter is about midway between the expanded diameter and the unexpanded diameter.

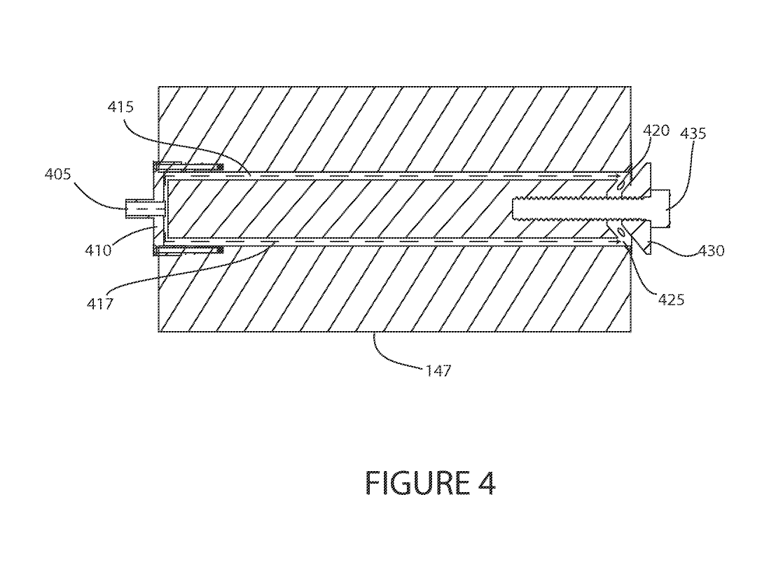

Optionally, a continuous or intermittent coating of a heat sensitive adhesive may be applied to the inner wall of the extruded pipe after extrusion and expansion, so that when the pipe is heat shrunk to take the shape of the substrate (e.g., piling) the adhesive creates a bond between the substrate and the PVC pipe. By way of example and not limitation, an adhesive applicator 147 may be provided downstream of the sizing mandrel 145. As the expanded pipe emerges from the sizing mandrel 145, hot melt adhesive is applied to the inner wall of the pipe. As conceptually illustrated in FIG. 4, an applicator 147 may include a supply port 405, through which hot melt adhesive is supplied via supply line 240. The source of the hot melt adhesive is the heated receptacle 115 using a gear pump. The hot melt adhesive may flow through a heat resistant nylon tube 240 that passes through the die spider located in the mid region of the die 120 and continues to connect with the sizing mandrel 145 and subsequently to the hot melt adhesive applicator 147 where the hot melt is evenly sprayed on the interior wall of the blown (i.e., expanded) pipe. The supply port may be fluidly coupled to a manifold 410 which feeds a plurality of channels, two of which 415, 417 are shown in the section view of the applicator 147 in FIG. 4. The channels 415, 417 define hot melt flow paths through applicator 147. An exit port 420, 425, is provided for each channel 415, 417. The exit ports 420, 425 emit hot melt adhesive along the inner sides of the pipe as it passes over the applicator 147. The hot melt adhesive flows from the exit ports 420, 425 through the space defined by the frustum cap 430 and the adjustment bolt 435. The space may be adjustable by tightening or loosening adjustment bolt 435.

After the reheated expanded pipe emerges from the expander 145, it enters another cooling tank 150, i.e., another spray or immersion cooling tank. The cooling tank 150 cools the pipe below its glass transition temperature (t_{g}) in order to set an expanded diameter. In an exemplary implementation, the pipe is cooled to below the t_{g}.

As the pipe emerges from the cooling tank 150, it has a diameter referred to herein as the expanded diameter. This diameter may be, for example, about eight inches. During heat shrinking, the diameter of the pipe will shrink from the expanded diameter towards the unexpanded diameter. This expanded diameter should be set to be greater than the diameter of the substrate.

The pipe is not limited to a structure having a circular cross section. Structures having non-circular cross section shapes (e.g., rectangular) may be produced in accordance with the principles of the invention. Thus, for examples, pipes having rectangular cross section shapes may encapsulate lumber and ties having rectangular cross section shapes. Additionally, pipes having shapes that differ from the shape of the substrate (e.g., a circular cross section pipe over a rectangular cross section substrate) may encapsulate the substrate. The heat shrinking action is sufficient to form a tight seal

Pullers 137, 155 provide the necessary forces to pull the pipe through the entire post extrusion operation. The pullers also maintain the proper wall thickness control by providing a constant pulling rate. The first puller 137 controls the wall thickness of the pre-expanded pipe and prevents the second puller 155 from influencing the pipe as it is drawn from the die. The second puller 155 controls the wall thickness of the expanded pipe. The rate at which the pipe is pulled, at least in part, determines the wall thickness of the finished pipe. Increasing the puller speed at a constant screw speed may reduce the wall thickness, while reducing the puller speed at the same screw speed may increase wall thickness. The two pullers may be electronically controlled and linked to precisely control the wall thickness of the expanded pipe.

The pipe is then cut by a cutter 160 into specified lengths for bundling, storage and shipping. The pipe may be cut into any desired lengths (e.g., 8, 10, 12, or 16 feet). Lengths that are not greater than 40 to 50 feet can be shipped easily by rail or truck. Bundling provides ease of handling and safety during loading and unloading.

The extrusion line may have one or more printing stations for printing notations on the pipe. An on-line gauging system may measure the product's outer diameter with a laser-based scanner. Such laser gauging systems have a very high measurement accuracy and a very high scanning rate for measurement averaging. Such gauging scanners are usually placed in the extrusion line after cooling and before the belt puller.

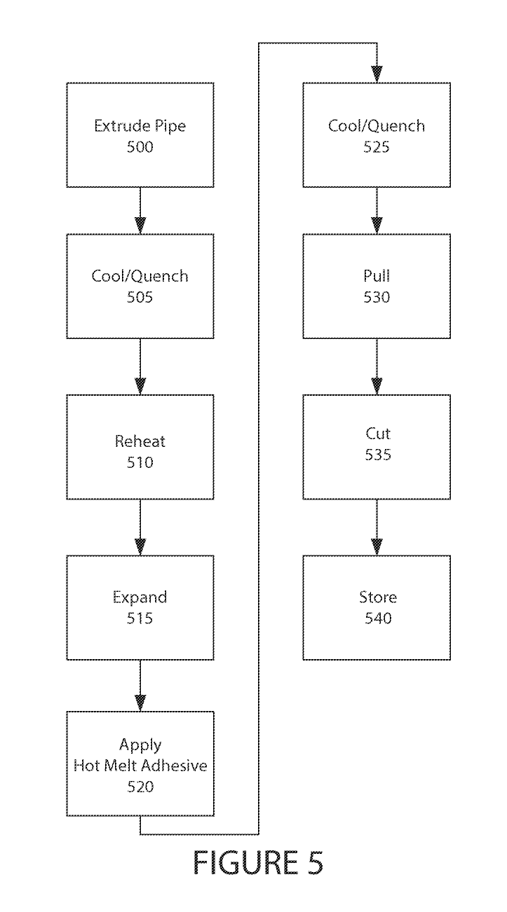

Referring now to FIG. 5, a high-level flowchart for an exemplary method of producing a seamless heat shrinkable sleeve according to principles of the invention is provided. In step 500, pipe is extruded from the die. The extruded pipe is then sized and cooled to below its glass transition temperature, as in step 505. After cooling, the pipe is reheated to the glass transition temperature or slightly above that temperature, as in step 510. The reheated pipe is then expanded, as in step 515. Expansion increases the diameter by about a factor of 2. Optionally, hot melt adhesive is applied to the inner surface of the pipe after the expansion process, as in step 520. The expanded reheated pipe is then cooled to below its glass transition temperature, as in step 525. The pipe is continuously pulled at a constant rate through the extrusion line stations at which the foregoing steps are performed, as in step 530. The pipe is then cut, as in step 535, for bundling, storage and shipping, as in step 540.

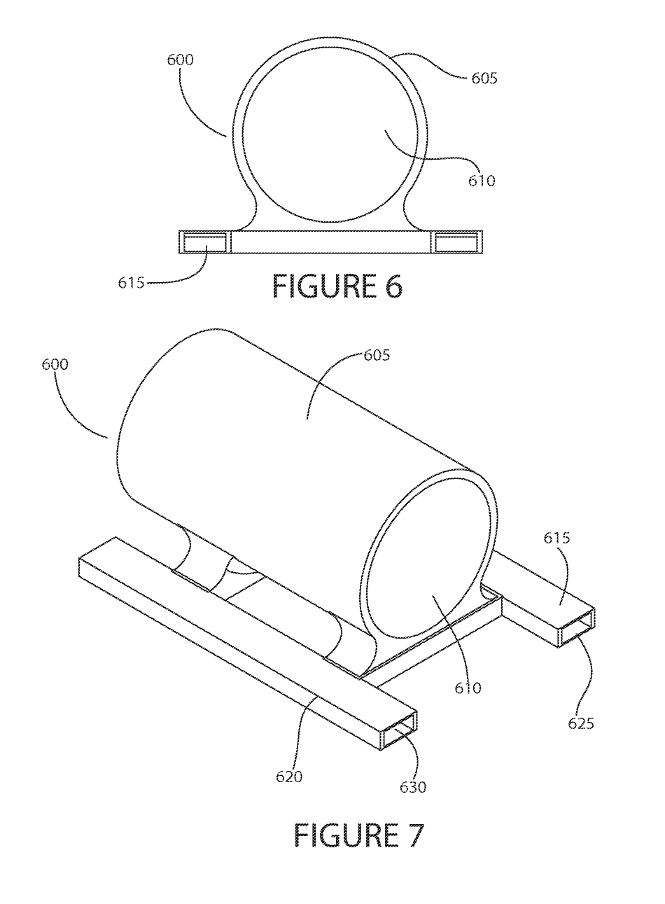

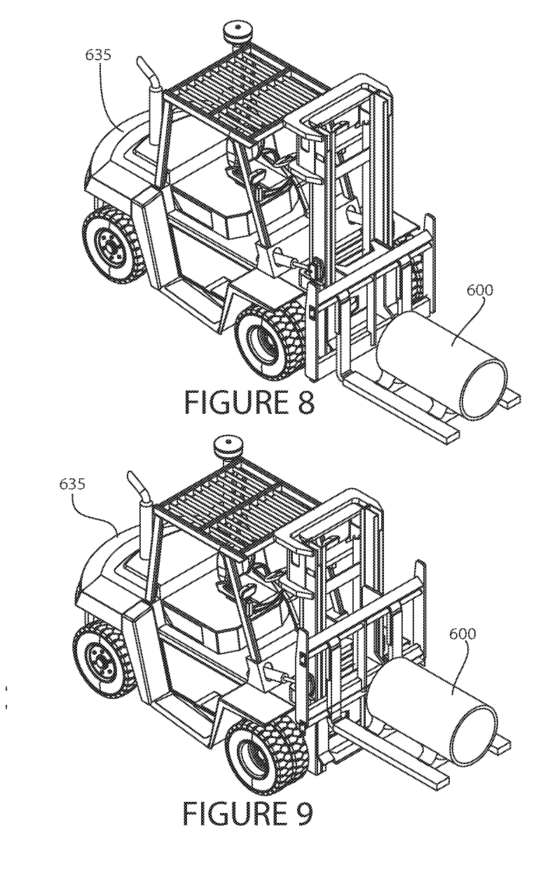

Referring now to FIGS. 6 and 7, an exemplary piling holder 600 for a forklift according to principles of the invention is shown. The piling holder 600 includes a hollow cylindrical tube 605 having an inner diameter that is greater than the diameter of the wood piling to be lifted. An end of the piling is inserted into the hollow space 610. A pair of fork sleeves 615, 620 are provided for receiving the forks of a forklift. The fork sleeves 615, 620, include compartments 625, 630 for receiving forks of a forklift. The tube 605 may be positioned above or below the forks. The piling holder 600 is shown in a lowered position on a forklift truck 600 in FIG. 8 and in a raised position in FIG. 9.

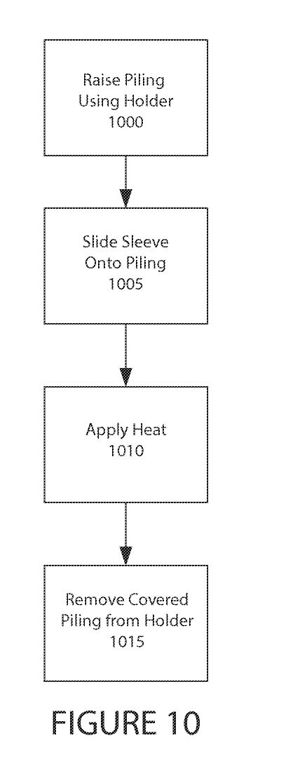

The piling holder 600 is used to lift a piling by an end, so that the extruded pipe may be slid onto the piling from the opposite end. FIG. 10 provides a flowchart for an exemplary method of applying a seamless heat shrinkable sleeve to a piling according to principles of the invention. In step 1000, the piling is raised, such as by using the piling holder 600 on a forklift. Then the pipe (i.e., sleeve) is slid onto the piling, as in step 1005. The sleeve does not have to cover the entire piling. The portion of the piling below the seabed does not have to be covered. The portion of the piling consistently above the sealevel does not have to be covered. The remaining portion of the piling should be covered. As the sleeve diameter is greater than the piling diameter, the sleeve should freely slide on the piling.

After the sleeve is correctly positioned over the portions of the piling to be protected, it is shrunk by applying heat, as in step 1010. Sufficient heat should be applied to raise the temperature of the piling to its glass transition temperature or slightly higher. The heat may be applied using one or more torches, heat lamps, and resistive heating elements. The heat source may be moved along the periphery of the sleeve to heat all portions of the sleeve as evenly as reasonably possible. This reheat causes the pipe to regress towards its original unexpanded extruded form, toward the unexpanded diameter.

After heat shrinking, the covered piling may be allowed to cool briefly and then removed from the holder, as in step 1015. After removal, the protected piling may be installed for use.

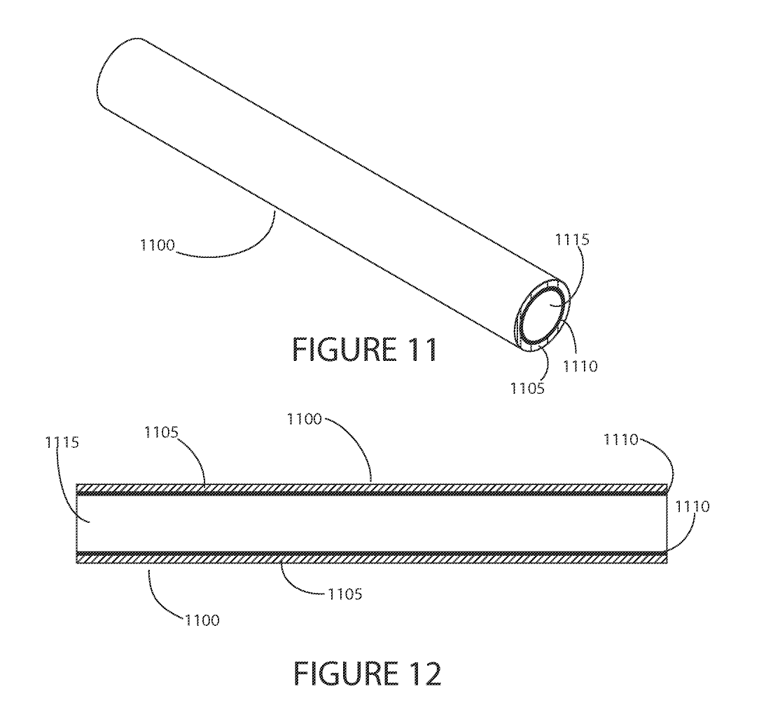

FIGS. 11 and 12 conceptually illustrate an exemplary extruded heat shrink protective seamless piling sleeve 1100 according to principles of the invention. In the exemplary embodiment the sleeve includes an outer PVC layer 1105 and an inner hot melt adhesive layer 1110. The channel 1115 defined by the PVC layer 1105 and the inner hot melt adhesive layer 1110 is sized to receive a wood substrate (i.e., a wood piling).

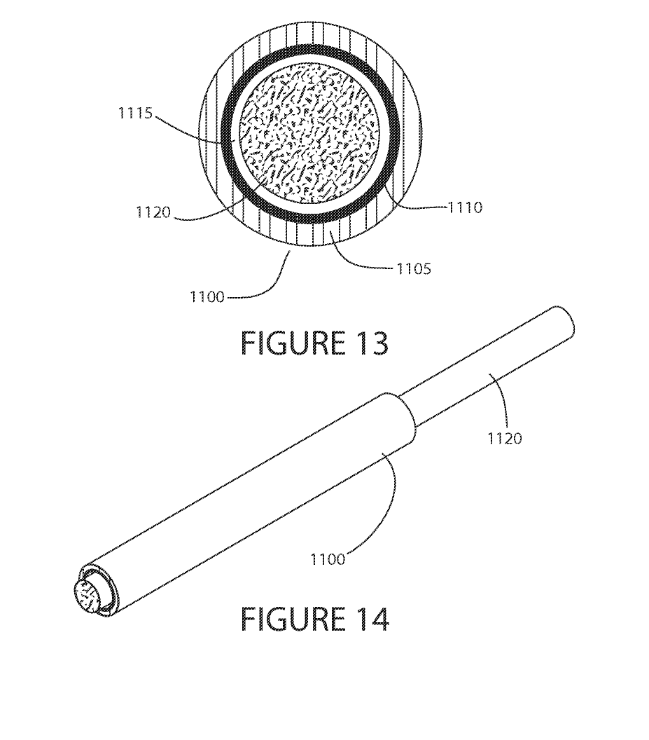

In FIGS. 13 and 14 views of the exemplary extruded heat shrink protective seamless piling sleeve with a surrounded piling and a gap between the piling and sleeve according to principles of the invention are provided. A wood substrate 1120 (e.g., piling) is shown in the channel space 1115. The diameter of the channel 1115 is greater than the diameter of the piling 1120, when the pipe 1100 is in the expanded, pre-shrunk state.

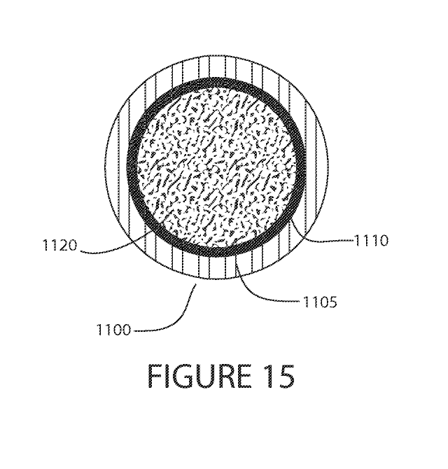

In FIG. 15, the pipe 1100 is shown in a shrunken state, after heat has been applied. The pipe 1100, in this case the hot melt adhesive layer 1110 of the pipe 1100, intimately contacts and bonds with the wood substrate, leaving no space therebetween. In an embodiment without the adhesive layer 1110, the inner surface of the PVC layer 1105 intimately contacts and abuts the wood substrate, leaving no appreciable space therebetween.

The resulting product is a piling with a seamless PVC shrink-wrapped sleeve covering at least a portion of the piling. By omitting seams, the product avoids risk of delamination and gapping that may allow intrusion by water and water borne organisms.

A fungicide may be included in the PVC dry blend or in the hot melt adhesive. Any fungicide suitable for extrusion processing and marine applications may be utilized within the scope of the present invention. Alternatively, a fungicide coating may be applied to the surfaces of the pipe after manufacturing.

Substrates to be protected by the pipe may comprise wood piling, dimensional lumber, railroad ties, fence posts, elongated metal structures such as steel beams, columns and posts, and the like. Any elongated structure having a diameter or maximum width that is less than the inner diameter or width of the pipe may be protected by the pipe. The pipe does not have to cover the entirety of the substrate. Rather, only the portion requiring protection may be covered. In some cases, the entirety of the substrate may require protection. In other cases, only a portion (e.g., a submerged portion) may require protection.

The pipe is not limited to a circular cross section. Other shapes, including but not limited to rectangular, I-beam, L, U, and other curvaceous or polygonal shapes may be produced within the scope of the invention.

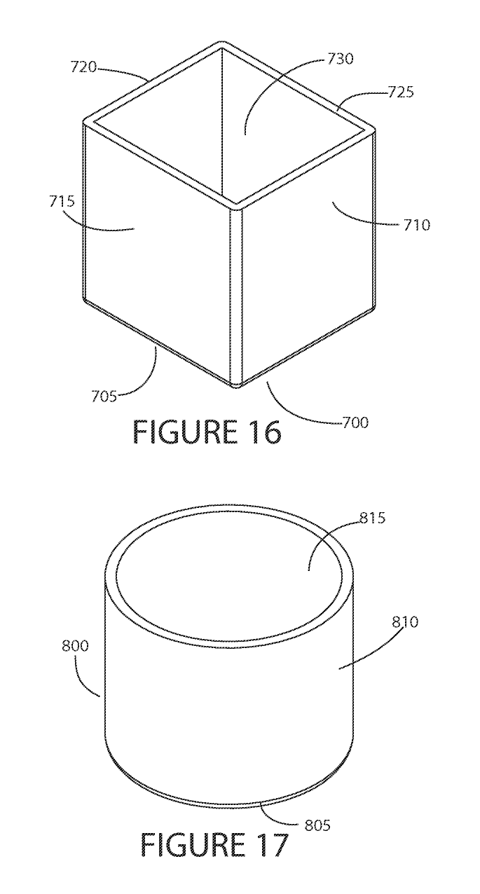

With reference to FIG. 16, a perspective view of a heat shrink rectangular end cap 700 for use with an exemplary extruded protective seamless piling sleeve according to principles of the invention is conceptually illustrated. The cap includes an end wall 705 and four flanges 710, 715, 720, 725 defining a compartment 730 into which the end of a piling, tie, beam or the like may be inserted. The cap 700 may be comprised of a PVC compound. The cap 700 is molded to its unexpanded dimensions, cooled, then reheated to about the glass transition temperature (t_{g}) and stretched to the expanded dimensions, and then cooled. Upon reheating after installation, the cap 700 will shrink towards its unexpanded dimensions. The cap 700 is sized such that the end of the substrate has dimensions between the unexpanded and expanded dimensions.

With reference to FIG. 17, a perspective view of a heat shrink circular end cap 800 for use with an exemplary extruded protective seamless piling sleeve according to principles of the invention is conceptually illustrated. The cap includes an end wall 805 and a continuous cylindrical flange 810 defining a compartment 815 into which the end of a piling, tie, beam or the like may be inserted. The cap 800 may be comprised of a PVC compound. The cap 800 is molded to its unexpanded dimensions, cooled, then reheated to about the glass transition temperature (t_{g}) and stretched to the expanded dimensions, and then cooled. Upon reheating after installation, the cap 800 will shrink towards its unexpanded dimensions. The cap 800 is sized such that the end of the substrate has dimensions between the unexpanded and expanded dimensions.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

1. A method of protecting a substrate, said method comprising steps of:
heating a PVC dry blend until a melt is formed;
extruding the melt through a die to form a seamless PVC pipe having an outer surface, an inner surface and an unexpanded inner diameter greater than two inches;
pulling the PVC pipe from the die with a first pipe puller to control a thickness of the PVC pipe;
cooling the extruded PVC pipe to a first temperature below a glass transition temperature for the PVC pipe;
after cooling the extruded PVC pipe to the first temperature below the glass transition temperature, heating the extruded PVC pipe to a second temperature equal to or greater than the glass transition temperature for the PVC pipe;
after heating the extruded PVC pipe to the second temperature, expanding the PVC pipe from the unexpanded inner diameter to an expanded inner diameter;
after expanding the PVC pipe, cooling the PVC pipe to a second temperature below the glass transition temperature for the PVC pipe;
placing the PVC pipe around a wooden substrate the substrate having a maximum width that is greater than the unexpanded inner diameter and less than the expanded inner diameter,
heating the PVC pipe while the substrate is positioned within the inner diameter of the PVC pipe to a third temperature equal to or greater than the glass transition temperature for the PVC pipe causing a shape of the inner surface of the PVC pipe to form to a shape of the substrate and remain proximate to the substrate thereby encapsulating at least a portion of the substrate with a protective coating comprising the PVC pipe.

2. The method of protecting a substrate according to claim 1, said unexpanded inner diameter being one quarter to three quarters of the expanded inner diameter.

3. The method of protecting a substrate according to claim 1, said step of extruding the melt through a die to form a seamless PVC pipe having an unexpanded inner diameter greater than two inches further comprising supplying a hot melt adhesive and coextruding the hot melt adhesive, said co-extruded hot melt adhesive covering at least a portion of the inner surface of the PVC pipe.

4. The method of protecting a substrate according to claim 1, further comprising, after expanding the PVC pipe, applying a hot melt adhesive onto the inner surface of the PVC pipe.

5. The method of protecting a substrate according to claim 1, said step of expanding the PVC pipe from the unexpanded inner diameter to the expanded inner diameter comprising passing the PVC pipe over a mandrel having a first cylindrical section with a first mandrel diameter about equal to the unexpanded inner diameter, and a second cylindrical section with a second mandrel diameter about equal to the expanded inner diameter, and a conical frustum disposed between and coupling the first cylindrical section to the second cylindrical section, said conical frustum, first cylindrical section and second cylindrical section being concentric.

6. The method of protecting a substrate according to claim 5, said mandrel further comprising a plurality of sizing discs, each of the plurality of sizing discs having a disc diameter about equal to the expanded inner diameter, and each of the plurality of sizing discs being concentric with the second cylindrical section and spaced apart from each other and the second cylindrical section.

7. The method of protecting a substrate according to claim 5, further comprising maintaining a negative pressure at the mandrel as the PVC pipe passes over a mandrel.

8. The method of protecting a substrate according to claim 1, said PVC dry blend including a fungicide.

9. The method of protecting a substrate according to claim 4, said hot melt adhesive including a fungicide.

10. The method of protecting a substrate according to claim 1, further comprising a step of cutting the PVC pipe to a determined length, after the step of cooling the PVC pipe to the second temperature below the glass transition temperature for the PVC pipe.

11. The method of protecting a substrate according to claim 1, further comprising steps of:
following the heating of the pipe to a second temperature, pulling the PVC pipe with a second puller synchronized with the first puller to maintain a desired PVC pipe wall thickness.

12. (canceled)

13. The method of protecting a substrate according to claim 11, wherein the step of sliding the PVC pipe over at least a portion of the substrate further comprises lifting the substrate with a forklift.

14. The method of protecting a substrate according to claim 13, wherein the step of lifting the substrate with a forklift, further comprises equipping forks of the forklift with a tubular holder, said tubular holder having an inner diameter greater than the expanded diameter of the PVC pipe, and said substrate being held in the tubular holder.

15. (canceled)

16. (canceled)

17. (canceled)

18. (canceled)

19. (canceled)

20. (canceled)

21. The method of protecting a substrate of claim 1, wherein the wooden substrate comprises a railroad tie.

22. The method of protecting a substrate of claim 1, wherein the wooden substrate comprises a fence post.

23. The method of protecting a substrate of claim 1, wherein the wooden substrate comprises a wooden piling.
